(19) United States
(12) Patent Application Publication
(10) Pub. No.: US 2006/0001951 A1
(43) Pub. Date: Jan. 5, 2006

(54) Fibre laser comprising a mode-selective cavity mirror

(76) Inventors: Michael Kempe, Kunitz (DE); Dirk Muhlhoff, Kunitz (DE); Stefan Mack, Freiburg (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/511,422

(22) PCT Filed: Apr. 11, 2003
(86) PCT No.: PCT/EP03/03794

§ 371 Date: Jun. 24, 2005

(30) Foreign Application Priority Data
Apr. 15, 2002 (DE) 102 16 627.7

(51) Int. Cl. H01S 3/30

(52) U.S. Cl. 359/341.1; 372/6

(57) ABSTRACT

The invention relates to a laser comprising a cavity which is defined by an end mirror and a decoupling mirror. A fibre comprising an active core is arranged in said cavity and can be excited by pump radiation until it has a multimodal laser activity, in such a way that a plurality of transversal modes form in the cavity. A mixture of modes is present in the fibre, and the decoupling mirror comprises reflection properties for laser and pump radiation, said properties varying according to the location, such that it reflects the pump radiation and the laser radiation which does not leave the active core of the fibre, and significantly decouples low transversal modes.

The invention relates to a laser comprising a resonator, which is limited by an end mirror and an output mirror and in which a fibre comprising an active core is arranged.

It is well-known from the literature to configure laser resonators such that a diffraction-limited light emission occurs. In all these arrangements, a suitable design of the resonator ensures that radiation having high beam quality is sufficiently amplified in the resonator. In contrast thereto, radiation having poor beam quality is suppressed by internal losses or by out-of-phase superposition. It is also known to use unstable resonators, e.g. from S. Townsend, J. Reilly, Unobscured unstable resonator design for large bore lasers, Proc. SPIE Vol. 0147, p. 184-188, 1989. Such fibre lasers have the disadvantage, however, that the beam quality of the pump radiation directly affects the beam quality of the emitted laser radiation. Since laser activity is primarily stimulated in the fibre core, the radiation intensity that can be coupled in is limited at the same time by the brilliance of the source of radiation for a given numerical aperture of the fibre. As a rule, the diameter of the fibre core then determines the diameter of the emitted beam. Double-core fibres offer a certain remedy here; however, they are complex and expensive in manufacture. Also, efficient coupling between the inner and outer core requires a great fibre length, which leads not only to increased constructional dimensions, but also to increased losses in the laser resonator due to inevitable scattering and absorption.

Due to this correspondence between the beam quality of the pumping source and the beam quality of the radiation emitted by the fibre laser, the use of a fibre laser has hitherto been linked inevitably with relatively complex pumping sources or has been limited by the power of the pumping source, respectively.

Therefore, it is an object of the invention to provide a fibre laser which is capable of generating laser radiation of high beam quality even when using pump radiation of poor beam quality.

According to the invention, the object is achieved by a laser comprising a resonator which is limited by an end mirror and an output mirror and in which a fibre is arranged that comprises an active core and can be stimulated by pump radiation to have multi-mode laser activity such that a plurality of transverse modes occur in the resonator, wherein mode mixing occurs in the fibre and the output mirror has reflection properties for laser and pump radiation which reflection properties vary locally such that the output mirror reflects pump radiation as well as laser radiation that does not exit from the active core of the fibre, and thus couples out low transverse modes predominantly.

Thus, according to the invention, a multi-mode field is deliberately stimulated in a fibre laser. The output mirror has the function of a mode stop which prefers a transmission of the basic mode, but largely suppresses coupling-out of radiation of higher transverse modes. Such higher modes preferably remain within the fibre, because due to mode mixing which always occurs in a fibre and can be optimized by means of fibre design and further measures, a renewed coupling-in of power from the higher mode into the basic mode occurs.

The concept according to the invention allows the use of a large coupling-in surface area for pump radiation without degrading the beam quality of the emitted laser radiation thereby. For example, monocore fibres having a very large core diameter can be used without the quality of the emitted radiation changing automatically as the cross section of the active core increases.

In addition to the basic mode, higher transverse modes are also formed, wherein the output mirror of the invention causes a corresponding mode selection for the laser beam. The efficient mode mixing in multi-mode fibres ensures that all propagable modes within the active medium are amplified and, thus, the inversion generated by a multi-mode pumping source can be efficiently used. Nevertheless, the coupling-out of radiation of higher or adjustable beam quality, respectively, is limited, and the radiation of lower beam quality remains within the resonator.

Moreover, the brilliance of the pumping source now no longer represents a noticeable limit for the power of the laser system. With a high numerical aperture of the fibre, a high pump radiation intensity can be coupled in without there being particularly high demands on the brilliance of the pumping source. The invention thus avoids the bottleneck caused, in the lasers according to the prior art, by the close link between the maximum input pump density (as a product of intensity and cross sectional area) and the diameter of the emitted laser beam. The diameter of the active core can now be selected to be much larger than the diameter of the emitted beam, so that the beam quality of the pump radiation can accordingly be inferior to that of the emitted laser radiation. In other words, this means that the beam quality of the emitted radiation in the laser according to the invention is improved over that of the pump radiation. This feature, which is actually known only for expensive double-core fibres, is now achieved in a much simpler way and without the aforementioned disadvantages of the double-core principle.

Further, the concept of defining the beam diameter by means of the output mirror also allows the use of fibres comprising active cores which are not circular in cross section. Thus, for example, a D-shaped cross section may be employed for the active core, which is particularly good for coupling different transverse modes with each other.

In a simple embodiment of the concept according to the invention, the output mirror comprises, and is preceded by, a mode stop having suitable properties. In many cases, however, the laser efficiency decreases if said mode stop does not reflect the pump radiation. It is therefore advantageous for this simple embodiment to provide the output mirror as a mode stop reflecting the pump radiation.

In a further embodiment of this simple design, the output mirror comprises an inner zone and an outer zone surrounding said inner zone, wherein said outer zone reflects laser radiation and pump radiation and said inner zone has a lower degree of reflectivity for laser radiation than the outer zone. The locally varying reflecting property of the output mirror is then realized in the form of two differently reflecting zones. The form of the inner zone has an effect on the beam cross section and will, thus, usually be selected depending on the particular application. Such an output mirror comprising an inner zone and an outer zone is relatively easy to manufacture, and may be manufactured, in particular, by coating one end of the fibre. Such direct coating is advantageous in view of the fact that no further separate adjusting steps are then required.

For most applications, a laser beam having a circular beam diameter is desired. The inner zone will then usually have a circular design. For this purpose, the inner zone is advantageously circular, having a smaller diameter than the diameter of the active core. The beam quality is increased from the coupled-in pump radiation to the coupled-out laser radiation by the ratio by which the inner zone is smaller than the cross sectional area of the active core. In this case, a suitable design of the inner zone relative to the cross sectional area of the active core allows selection of almost any desired ratio.

In view of easy manufacture it is preferred not to provide the output mirror directly on the end of a fibre, but to realize it as a discrete element, wherein beam-expanding optics may optionally be provided, too, between the end of the fibre and the output mirror. In order to achieve the amplified output of low transverse modes, i.e. in order to obtain laser radiation that is as monomodal as possible, the cross section of the inner zone is, in this case, always smaller than the expanded cross section of the active core. For a circular inner zone and a circular active core it is then advantageous, for example, to provide the inner zone with a smaller diameter than the expanded diameter of the active core.

A further possibility to shape the generated laser radiation in terms of beam profile, intensity distribution and propagation characteristics with a view to the requirements of particular applications is to arrange the inner zone such that it is not coaxial to the radiation exiting the active core. This allows selective admixing of higher transverse modes, which has a direct effect on intensity distribution and, thus, on the beam profile.

In the concept according to the invention, the radiation which has not been coupled out is reflected back again and remains in the resonator. Said radiation is, in particular, radiation of higher transverse modes which are stimulated due to the geomety of the resonator and, in particular, in the case of a high numerical aperture of the active core of the fibre in the resonator. The mixture of different transverse modes achieves a very uniform intensity distribution over the cross section of the inner zone of the output mirror. The energy of radiation from modes (which have not been coupled out) is reflected back again into the resonator and is ultimately introduced into the coupled-out low transverse modes by mode mixing which inherently occurs in the fibre. In order to promote said mode mixing, a layout of the fibre in loops or bends is advantageous.

A further possibility to amplify the internal mode mixing of the fibre in the laser according to the invention consists in using a fibre whose active core has a D-shaped cross section. In such fibres, the mode-mixing properties are particularly pronounced. Therefore, they are especially suitable for the laser according to the invention.

The properties of the output mirror define the beam cross section of the coupled-out laser beam. In a resonator allowing stimulation of laser activity at a plurality of wavelengths, the spectral reflection properties of the output mirror also have an effect on the spectral composition of the emitted laser beam. Thus, a suitable selection of the reflection properties or of the transmission properties, respectively, of the output mirror allows both the diameter and the wavelength of the output laser beam to be influenced. This makes it possible to easily obtain an adjustable or switchable laser, respectively, by providing an exchangeable output mirror.

The invention will be explained in more detail below, by way of example and with reference to the Figures, wherein:

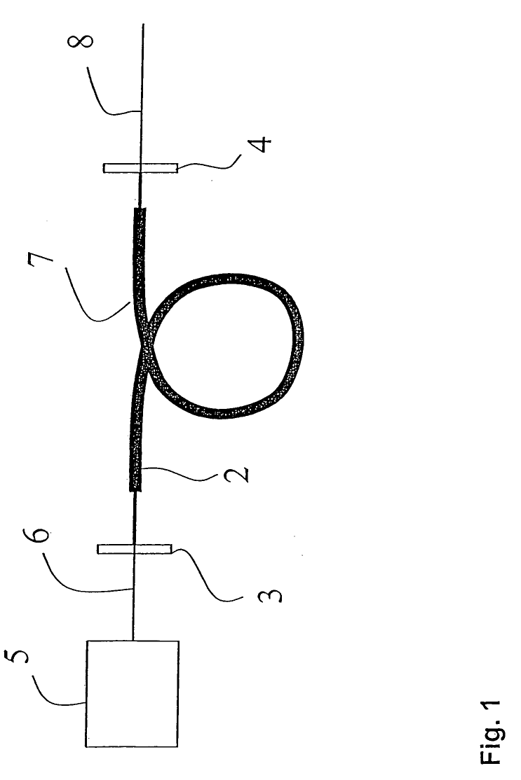

FIG. 1 shows a schematic drawing of a fibre laser;

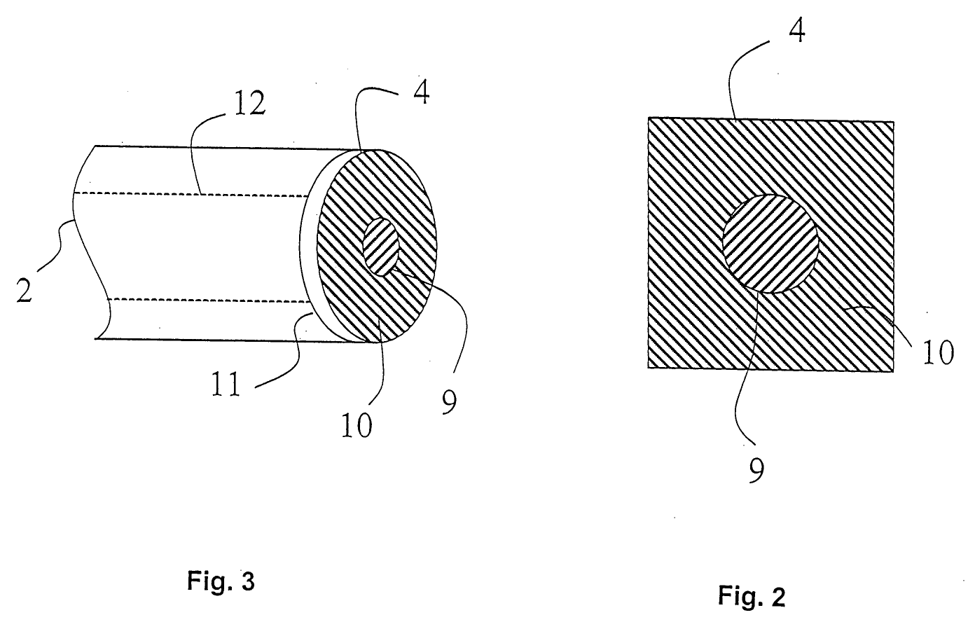

FIG. 2 shows a schematic representation of an end surface of the fibre of the fibre laser with an output mirror provided thereon;

FIG. 3 shows a top view of the end surface of FIG. 2;

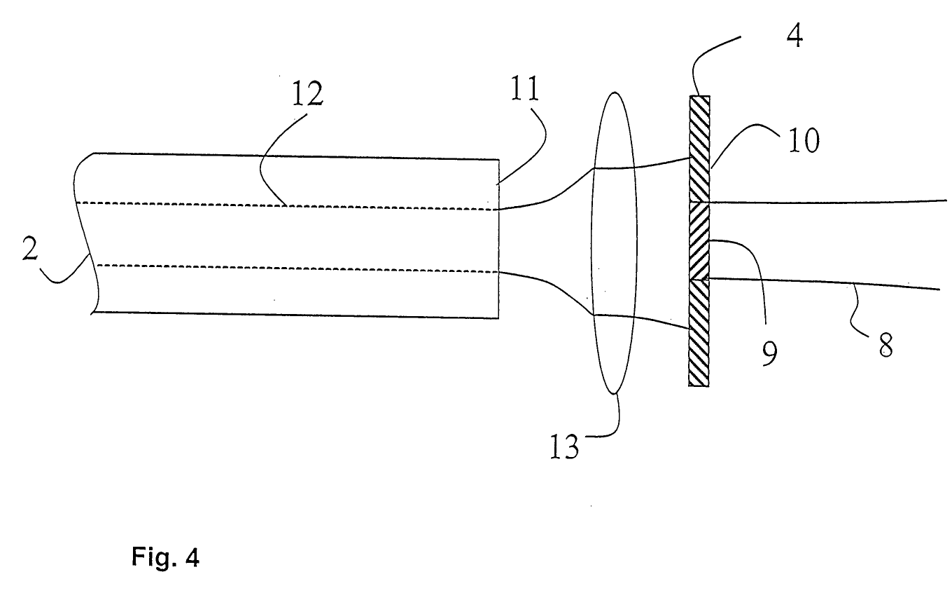

FIG. 4 shows a schematic representation of a further output miror;

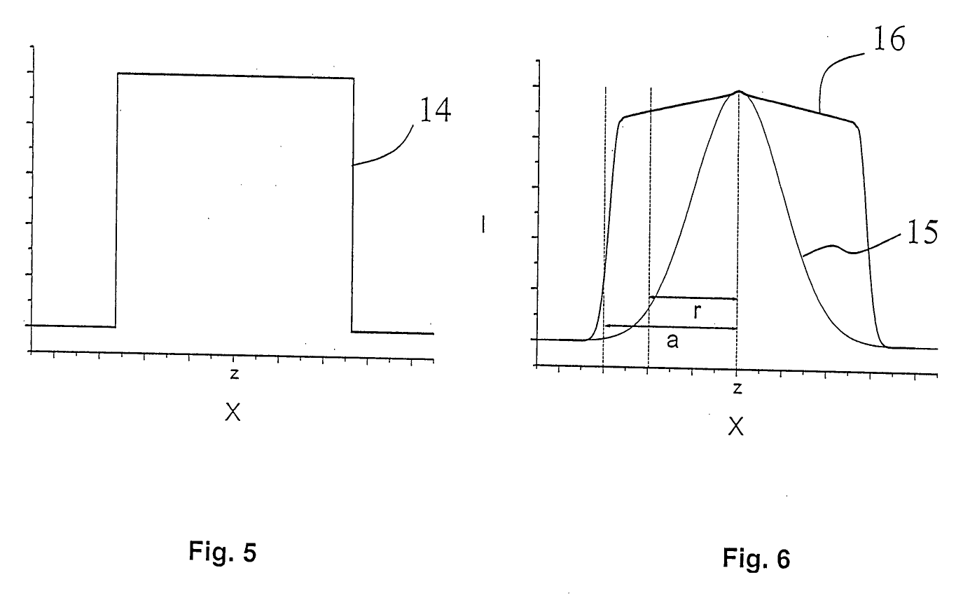

FIG. 5 shows a graph illustrating the beam profile, and

FIG. 6 shows a section through the end surface of a fibre of a laser in a graph illustrating the intensity of one mode.

The fibre laser 1 shown in FIG. 1 comprises a fibre 2 which is located in a resonator. The resonator is formed by an end mirror 3 as well as an output mirror 4. At the end mirror 3, pump radiation 6 is coupled into the active core of the fibre 2 via a pumping source 5. The pumping source 5 may be one or more laser diodes, for example. Due to a suitable coating, the end mirror 3 is transparent for pump radiation and highly reflective for laser radiation stimulated in the fibre 2. With respect to its diameter or its numerical aperture, respectively, the active core of the fibre is dimensioned such that a plurality of transverse modes can be generated by said stimulation. Due to the inherent properties of the fibre 2, mode mixing of the radiation formed in the resonator occurs. Said mode mixing is additionally enhanced by a layout of the fibre 2 in bends 7. For example, it is possible to wind the fibre 2 around a core.

A laser beam 8 exits from the output mirror 4 during pumped operation. The wavelength and the cross section of said beam are determined by the laser activity in the fibre 2 as well as by properties of the output mirror 4 which shall be described hereinafter.

The resonator of FIG. 1 comprises separate end mirrors 3 and 4. It is possible, however, to provide the end surfaces of the fibre 2 directly with one or both of said mirrors. FIG. 2 schematically shows the output mirror 4. As can be seen, the output mirror 4 comprises two zones, an inner zone 9 and an outer zone 10. The inner zone 9 of the output mirror 4 transmits radiation at the laser wavelength. In contrast thereto, it reflects the pump radiation. The outer zone 10, however, is reflective at both the wavelength of the laser radiation and the wavelength of the pump radiation and prevents pump or laser radiation from exiting in the area of the outer zone 10.

FIG. 3 shows an enlarged top view of the fibre 2 in the area of the end surface 11. The end surface is provided directly with the output mirror 4; the outer zone 10 and the inner zone 9 are illustrated by differently shaded areas. The inner zone 9 is noticeably smaller than the cross section of the fibre core 12. Since only the inner zone 9 transmits radiation at the laser wavelength, laser radiation 8 is coupled out from the output mirror 4 only there.

Since laser radiation which consists of a mixture of transverse modes is generated in the fibre 2, i.e. in its fibre core 12, as already explained, not only pump radiation, but also the aforementioned mode mixture, is directed on the output mirror 4 from the fibre side of the mirror. The zone 9, which transmits laser radiation only in a partial region of the fibre core 12, thus causes a mode selection such that the radiation with regard to the basic mode predemoninantly exits at the output mirror 4. Radiation of higher transverse modes is reflected back into the fibre 2 where, due to the mode-mixing properties of the fibre 2, said radiation ultimately couples in again into the low transverse modes transmitted by the output mirror 4, after several round-trips, if required.

FIG. 4 shows a further representation of how the output mirror 4 can be embodied. It is not provided on the end surface 11 of the fibre 2 therein, but is embodied as a separate, spaced apart element, which is easier to manufacture. Expansion of the radiation exiting from the fibre 2 occurs between the end surface 11 and the output mirror 4 with intermediately arranged optics 13. Said expansion has an effect especially on the laser radiation exiting from the fibre core 12.

In this case, the radiation of higher transverse modes diverges more strongly than that of the basic mode (not shown in FIG. 4). The output mirror 4 arranged following the optics 13 principally corresponds to that represented in FIG. 2, i.e. it comprises an inner zone 9, which transmits radiation at the laser wavelength, and an outer zone 10 surrounding the inner zone 9 and reflecting radiation back again to the end surface 11 of the fibre 2 both at the laser wavelength and at the wavelength of the pump radiation.

The laser radiation of all transverse modes stimulated in the fibre 2 is directed onto the output mirror 4, with the aforementioned beam expansion being amplified by the varying divergence of the different modes. Therefore, in some cases, the surface area of the inner zone 9 is greater than the cross sectional area of the fibre core 12, without eliminating the desired preference of the low or basic mode by the inner zone 9 during transmission. The desired mode-filtering property of the output mirror 4 is ensured in that the surface area of the inner zone is much smaller than the expanded radiation of the low modes to be selected, in particular the basic mode, said expanded radiation coming from the fibre core 12.

In a graph 14, FIG. 5 shows the intensity I of the laser beam 8 over the cross section in the x-direction. As can be seen, an almost stepped profile, which is referred to as a so-called top hat profile, is formed with symmetry to the center z. Of course, this stepped profile requires that not only the basic mode is transmitted (whose intensity distribution, while also having symmetry to the center z, does not drop in a step-like fashion), but also that the inner zone 9 causes higher modes to be admixed during transmission, so that the superposition of the radiation of the individual modes as a whole results in the stepped profile. The admixing of higher modes or the composition of the output laser beam 8 of radiation of several transverse modes, respectively, naturally also has an effect on the propagation characteristics of the laser beam 8, i.e. on the angle of divergence of the radiation. Radiation components of higher modes diverge more strongly.

The design of the inner zone 9 in relation to the fibre core 12 allows the beam profile or the propagation characteristics, respectively, to be designed as desired. There is no restriction to symmetric intensity distributions here, as shown in FIG. 5, but it is possible also to achieve an asymmetric intensity profile or an asymmetric propagation characteristic, respectively, which does not have symmetry to the center z, by means of an off-axis position of the inner zone 9, relative to the axis of the fibre core 12 or to the axis of radiation exiting therefrom, respectively.

This effect of the inner zone 9 is schematically illustrated in FIG. 6, which shows an intensity profile 15 corresponding to the basic mode. The intensity profile 15 drops from a maximum to a 1/e²-proportion, over a radius r, starting from the center z. In multi-mode fibres, the radius r is clearly smaller than the fibre core radius a, which corresponds approximately to the radius of the intensity distribution 14 of multi-mode radiation. By coupling-out radiation within the radius r, radiation of the basic mode is preferred and the emitted laser radiation in the laser beam 8 has a better beam quality than the pump radiation 6. The pump radiation 6 may be coupled in over a larger cross section at the end mirror 3, which increases the maximum power that can be coupled in and thus the power of the fibre laser 1. The limitation due to the brilliance of the pumping source 5 is thus eliminated. The intensity of higher modes has a slighter radial drop than that of the basic mode; thus, higher modes extend transversely over a greater radius. Therefore, use is made of a fibre 2 whose fibre core 12 has a greater radius than the radius r. The coupling-out radius is smaller than the radius a and preferably greater than the radius r.

1-9. (canceled)

10. A laser comprising a resonator which is limited by an end mirror and an output mirror and in which a fibre is arranged that comprises an active core and can be stimulated by pump radiation to have multi-mode laser activity such that a plurality of transverse modes occur in the resonator,
wherein mode mixing occurs in the fibre, and
wherein the output mirror has reflective properties for laser and pump radiation varying such that the output mirror reflects pump radiation as well as laser radiation that does not exit from the active core of the fibre and thus predominantly couples out low transverse modes.

11. The laser of claim 10, wherein said fibre has a layout in loops or in bends so as to promote mode mixing.

12. The laser of claim 10, wherein the fibre active core has a D-shaped cross section.

13. The laser of claim 10, wherein said output mirror is exchangeable, thereby providing for switching a wavelength of the laser or a diameter of a laser beam emitted from the laser.

14. The laser of claim 10, wherein the output mirror is exchangeable and comprises an inner zone and an outer zone surrounding said inner zone.

15. The laser of claim 14, wherein said outer zone reflects laser radiation and pump radiation and said inner zone has a lower reflectivity for laser radiation than the outer zone.

16. The laser of claim 14, wherein the inner zone is not coaxial to the radiation exiting from the active core.

17. The laser of claim 14, wherein the inner zone is generally circular, having a smaller diameter than the diameter of the active core.

18. The laser of claim 10, further comprising beam-expanding optics arranged between an end of the fibre and the output mirror.

19. A method of generating a laser beam from a laser, the laser comprising a resonator limited by an end mirror and an output mirror, a fibre comprising an active core and stimulated by pump radiation to have multi-mode laser activity such that a plurality of transverse modes occur in the resonator, wherein mode mixing occurs proximate an end of the fibre, and wherein the output mirror has varying reflective properties for laser and pump radiation such that the output mirror reflects pump radiation and laser radiation not exiting from the active core, thereby coupling out low transverse modes, the method comprising activating said laser.

20. A method of manufacturing a laser, comprising:
providing a pumping source; and
positioning a fibre between an end mirror and an output mirror such that said pumping source will emit a light beam directed at said end mirror,
wherein said fiber comprises an active core and can be stimulated by pump radiation to have a multi-mode laser activity such that a plurality of transverse modes,
wherein mode mixing occurs in said fibre when said laser is activated; and
wherein said output mirror has reflective properties for laser and pump radiation varying such that the output mirror reflects pump radiation and laser radiation not exiting from said active core, thereby coupling out low transverse modes.

21. The method of claim 20, wherein said fibre looped so as to promote mode mixing.

22. The method of claim 20, wherein said fibre is bent so as to promote mode mixing.

23. The method of claim 20, wherein the output mirror is exchangeable and comprises an inner zone and an outer zone, thereby providing for switching a wavelength of a beam emitted by the laser or a diameter of a beam emitted by the laser.

24. The method of claim 23, wherein said inner zone is not coaxial to radiation emitted from the active core.

25. The method of claim 23, wherein the inner zone is generally circular and having a smaller diameter that a diameter of the active core.

26. The method of claim 20, wherein the laser further comprises beam-expanding optics arranged between an end of the fibre and the output mirror.
